(19) United States
(12) Patent Application Publication
(10) Pub. No.: US 2024/0171403 A1
(43) Pub. Date: May 23, 2024

(54) INTEGRITY-BASED IMPLEMENTATION OF CONTENT USING DIGITALLY SIGNED SECURE QUICK RESPONSE CODE

(71) Applicant: Intel Corporation, Santa Clara, CA (US)

(72) Inventors: Karthika Murthy, Bangalore (IN); Santosh Male, Hyderabad (IN); Girisha Dengi, Bengaluru (IN)

(73) Assignee: Intel Corporartion, Santa Clara, CA (US)

(21) Appl. No.: 18/058,475

(22) Filed: Nov. 23, 2022

(51) Int. Cl. H04L 9/32; G06K 19/06

(52) U.S. Cl. CPC H04L 9/3228; G06K 19/06037; H04L 9/3247

(57) ABSTRACT

A system and method of implementing digitally signed secure quick response (SQR) codes include storing captured content as a hash map, calculating a hash of the captured content, where the hash is a unique key that is stored in the hash map, creating a digital signature for the captured content using a private key such that the captured content is digitally signed, generating a SQR code of the digitally signed captured content, and storing the SQR code including the digitally signed captured content in a secure digital (SD) card.

### FIELD

Embodiments relate generally to computer security, and more particularly, to an integrity-based implementation of content using digitally signed secure quick response (SQR) code.

### BACKGROUND

Readily accessible digital manipulation techniques are often used to execute content (e.g., photo/video) morphing attacks. Photos and videos, for example, are no longer a trusted source and are susceptible to morphing attacks. Theft and personal space privacy breach of photo/video has become common. Current techniques prevent manipulation, theft, and attacks of content include password protection, access restriction, and encryption. However, such techniques result in the escalation of privilege in a cloud server here a copy of data transfer is stored.

### BRIEF DESCRIPTION OF THE DRAWINGS

So that the manner in which the above recited features of the present embodiments can be understood in detail, a more particular description of the embodiments, briefly summarized above, may be had by reference to embodiments, some of which are illustrated in the appended drawings. It is to be noted, however, that the appended drawings illustrate only typical embodiments and are therefore not to be considered limiting of its scope. The figures are not to scale. In general, the same reference numbers will be used throughout the drawings and accompanying written description to refer to the same or like parts.

FIG. 1 illustrates a computing device employing a content integrity mechanism according to some embodiments.

FIG. 2 illustrates the content integrity mechanism of FIG. 1 according to some embodiments.

FIG. 3 illustrates a method for generating digitally signed secure quick response (SQR) codes according to some embodiments.

FIG. 4 illustrates a method for verifying digitally signed secure quick response (SQR) codes according to some embodiments.

FIG. 5A is a schematic diagram of an illustrative electronic computing device to perform digitally signed secure quick response (SQR) code processing according to some embodiments.

FIG. 5B is a schematic diagram of an illustrative electronic computing device to perform digitally signed secure quick response (SQR) code processing according to some embodiments.

### DETAILED DESCRIPTION

Implementations of the technology described herein provide a method and system for an integrity-based implementation of content using digitally signed secure quick response (SQR) code.

Readily accessible digital manipulation techniques are often used to execute content (e.g., photo/video) morphing attacks. Photos and videos, for example, are no longer a trusted source and are susceptible to morphing attacks. Theft and personal space privacy breach of photo/video has become common. Current techniques to prevent manipulation, theft, and attacks of content include password protection, access restriction, and encryption. However, such techniques result in the escalation of privilege in a cloud server where a copy of data transfer is stored.

The novel technology described herein facilitates capturing content (e.g., a photo/image or video) in the form of a digitally signed SQR code and transferring the content in an SQR code format. For example, content may be captured and a digitally signed SQR code of the content may be generated. In this regard, the SQR code including the content may be stored and transmitted securely. The digitally signed SQR code may be validated and verified programmatically to view the content. In one example, an additional hash check may be implemented at the content source device and destination device.

As such, the novel technology presented may facilitate sharing private pictures and videos, sensitive data, passwords, and the like securely over a network. The novel technology establishes trust on the content. In one scenario, the technology establishes trust on photo/video evidence in the field of law enforcement. In one example, photos/images and videos may be shared via photo or video sharing applications such as WhatsApp, Google share, and the like, as a SQR code with visual proof of encrypted information. In this regard, a user may experience the presence of a secure environment while transferring personal content such as photos and videos.

The digitally signed SQR code solution is easy to implement and provides tamper-proof, theft-proof, and instantly verifiable content such as photos and videos resulting in protection of the integrity of the content. In one example, the SQR code may be self-contained such that the content may be validated without a network connection. Thus, the novel solution can be implemented any time and anywhere including in secure air-gapped environments.

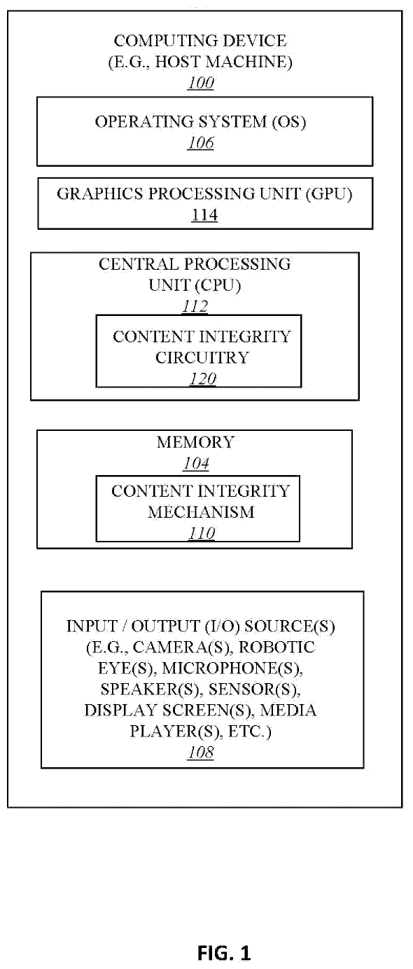

FIG. 1 illustrates a computing device 100 employing a content integrity mechanism 110 according to one embodiment. Computing device 100 represents a communication and data processing device including or representing (without limitation) smart voice command devices, intelligent personal assistants, home/office automation system, home appliances (e.g., washing machines, television sets, etc.), mobile devices (e.g., smartphones, tablet computers, etc.), gaming devices, handheld devices, wearable devices (e.g., smartwatches, smart bracelets, etc.), virtual reality (VR) devices, head-mounted displays (HMDs), Internet of Things (IoT) devices, laptop computers, desktop computers, server computers, set-top boxes (e.g., Internet-based cable television set-top boxes, etc.), global positioning system (GPS)-based devices, automotive infotainment devices, etc.

In some embodiments, computing device 100 includes or works with or is embedded in or facilitates any number and type of other smart devices, such as (without limitation) autonomous machines or artificially intelligent agents, such as a mechanical agents or machines, electronics agents or machines, virtual agents or machines, electro-mechanical agents or machines, etc. Examples of autonomous machines or artificially intelligent agents may include (without limitation) robots, autonomous vehicles (e.g., self-driving cars, self-flying planes, self-sailing boats, etc.), autonomous equipment (self-operating construction vehicles, self-operating medical equipment, etc.), and/or the like. Further, “autonomous vehicles” are not limited to automobiles but that they may include any number and type of autonomous machines, such as robots, autonomous equipment, household autonomous devices, and/or the like, and any one or more tasks or operations relating to such autonomous machines may be interchangeably referenced with autonomous driving.

Further, for example, computing device 100 may include a computer platform hosting an integrated circuit (“IC”), such as a system on a chip (“SoC” or “SOC”), integrating various hardware and/or software components of computing device 100 on a single chip. For example, computing device 100 comprises a data processing device having one or more processors including (but not limited to) central processing unit 112 and graphics processing unit 114 that are co-located on a common semiconductor package.

As illustrated, in one embodiment, computing device 100 may include any number and type of hardware and/or software components, such as (without limitation) graphics processing unit (“GPU” or simply “graphics processor”) 114, central processing unit (“CPU” or simply “application processor”) 112, memory 104, network devices, drivers, and/or the like, as well as input/output (I/O) source(s) 108, such as touchscreens, touch panels, touch pads, virtual or regular keyboards, virtual or regular mice, ports, connectors, etc. Computing device 100 may include operating system (OS) 106 serving as an interface between hardware and/or physical resources of the computing device 100 and a user.

It is to be appreciated that a lesser or more equipped system than the example described above may be preferred for certain implementations. Therefore, any configuration of computing device 100 may vary from implementation to implementation depending upon numerous factors, such as price constraints, performance requirements, technological improvements, or other circumstances.

Embodiments may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA). Terms like “logic”, “module”, “component”, “engine”, “circuitry”, “element”, and “mechanism” may include, by way of example, software, hardware, firmware, and/or a combination thereof.

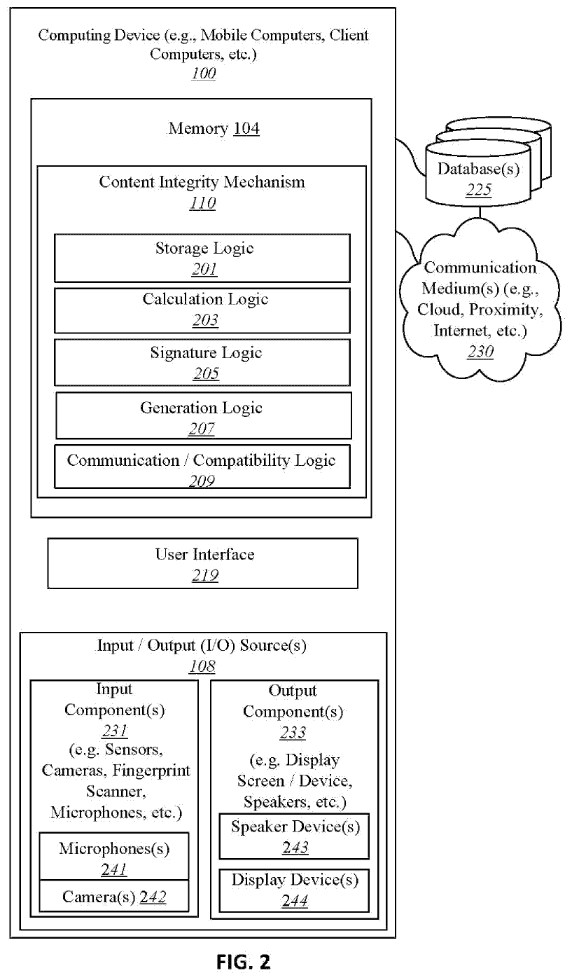

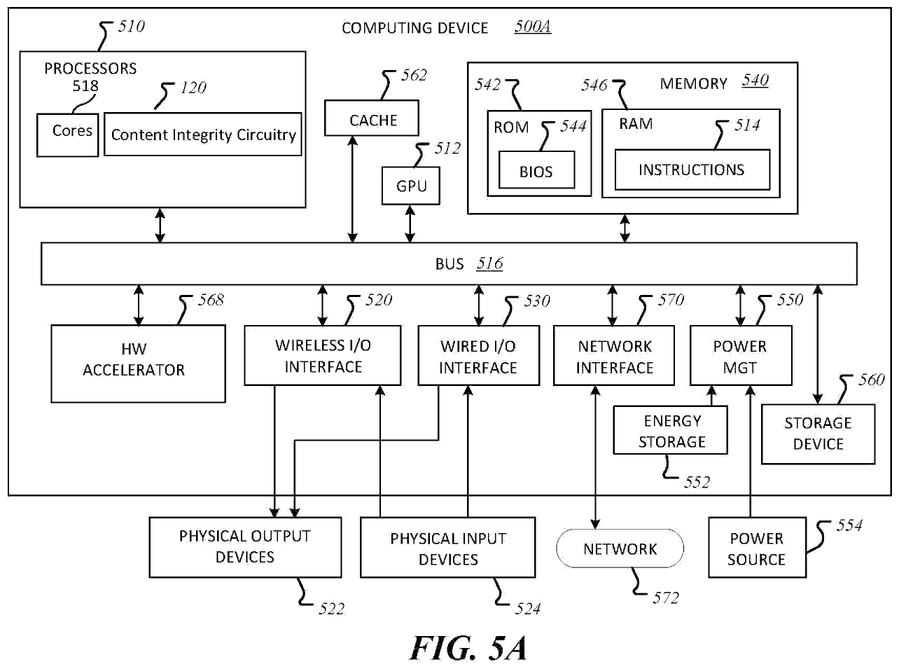

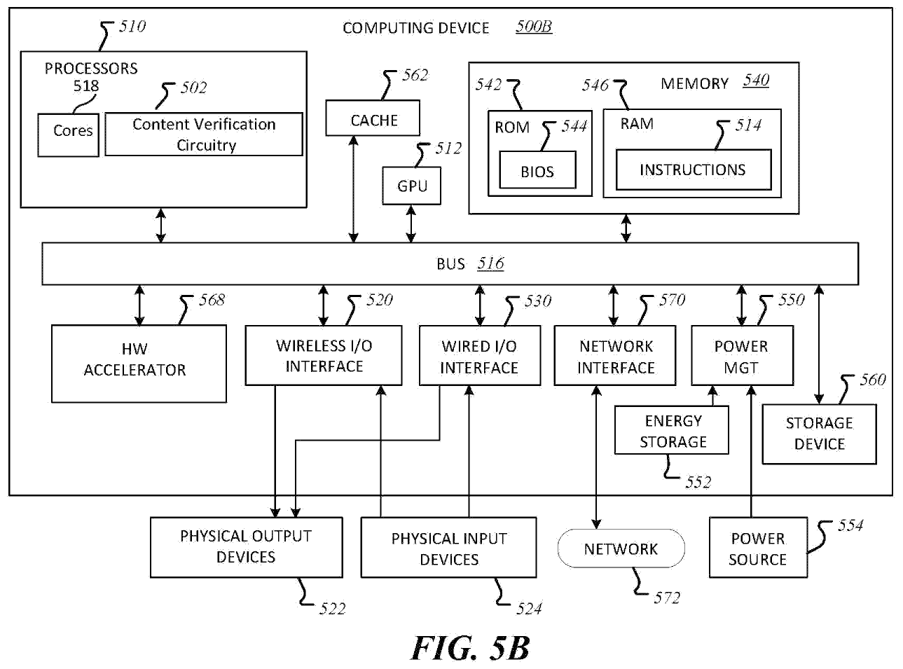

In one embodiment, as illustrated, the content integrity mechanism 110 may be hosted by memory 104 (e.g., in the form of instructions stored in memory 104 as shown in FIG. 2) in communication with I/O source(s) 108, such as cameras, sensors, microphones, speakers, etc., of computing device 100. In another embodiment, content integrity mechanism 110 may be part of or hosted by operating system 106. Similarly, in yet another embodiment, content integrity mechanism 110 may be hosted by or part of central processing unit (“CPU” or simply “application processor”) 112 in the form of content integrity circuitry 120 as shown in the processor of FIG. 5A.

For example, content integrity circuitry 120 and/or any elements of content integrity mechanism 110 may be implemented by one or more analog or digital circuits, logic circuits, programmable processors, programmable controllers, GPUs, digital signal processors (DSPs), application specific integrated circuits (ASICs), programmable logic devices (PLDs), and/or field programmable logic devices (FPLDs).

It is contemplated that this novel technique is not limited to a software implementation or a hardware implementation and, as will be further described in this document, this novel technique may be applied and implemented in software, hardware, firmware, or any combination thereof. It is, therefore, further contemplated that embodiments are not limited to certain implementation or hosting of content integrity mechanism 110 and that one or more portions or components of content integrity mechanism 110 may be employed or implemented as hardware, software, firmware, or any combination thereof. Further, as used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events

Computing device 100 may host network interface device(s) to provide access to a network, such as a LAN, a wide area network (WAN), a metropolitan area network (MAN), a personal area network (PAN), Bluetooth, a cloud network, a mobile network (e.g., 3rd Generation (3G), 4th Generation (4G), etc.), an intranet, the Internet, etc. Network interface(s) may include, for example, a wireless network interface having antenna, which may represent one or more antenna(e). Network interface(s) may also include, for example, a wired network interface to communicate with remote devices via network cable, which may be, for example, an Ethernet cable, a coaxial cable, a fiber optic cable, a serial cable, or a parallel cable.

Embodiments may be provided, for example, as a computer program product which may include one or more machine-readable media having stored thereon machine-executable instructions that, when executed by one or more machines such as a computer, a data processing machine, a data processing device, network of computers, or other electronic devices, may result in the one or more machines carrying out operations in accordance with embodiments described herein. As described with reference to FIG. 1, a machine may include one or more processors, such as a CPU, a GPU, etc. A machine-readable medium may include, but is not limited to, floppy diskettes, optical disks, Compact Disc-Read Only Memories (CD-ROMs), magneto-optical disks, ROMs, Random Access Memories (RAMs), Erasable Programmable Read Only Memories (EPROMs), Electrically Erasable Programmable Read Only Memories (EEPROMs), magnetic or optical cards, flash memory, or other type of media/machine-readable medium suitable for storing machine-executable instructions.

For example, when reading any of the apparatus, method, or system claims of this disclosure to cover a purely software and/or firmware implementation, at least one element of content integrity circuitry 120 and/or content integrity mechanism 110 may be expressly defined to include a non-transitory computer readable storage device or storage disk such as a memory, a digital versatile disk (DVD), a compact disk (CD), a Blu-ray disk, etc., including the software and/or firmware.

Moreover, one or more elements of content integrity circuitry 120 or content integrity mechanism 110 may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

Throughout this document, the term “user” may be interchangeably referred to as “viewer”, “observer”, “speaker”, “person”, “individual”, “end-user”, “developer”, “programmer”, “administrators”, and/or the like. For example, in some cases, a user may refer to an end-user, such as a consumer accessing a client computing device, while, in some other cases, a user may include a developer, a programmer, a system administrator, etc., accessing a workstation serving as a client computing device. It is to be noted that throughout this document, terms like “graphics domain” may be referenced interchangeably with “graphics processing unit”, “graphics processor”, or simply “GPU”; similarly, “CPU domain” or “host domain” may be referenced interchangeably with “computer processing unit”, “application processor”, or simply “CPU”.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document.

In some embodiments, terms like “display screen” and “display surface” may be used interchangeably referring to the visible portion of a display device while the rest of the display device may be embedded into a computing device, such as a smartphone, a wearable device, etc. It is contemplated and to be noted that embodiments are not limited to any particular computing device, software application, hardware component, display device, display screen or surface, protocol, standard, etc. For example, embodiments may be applied to and used with any number and type of real-time applications on any number and type of computers, such as desktops, laptops, tablet computers, smartphones, head-mounted displays and other wearable devices, and/or the like. Further, for example, rendering scenarios for efficient performance using this novel technique may range from simple scenarios, such as desktop compositing, to complex scenarios, such as 3D games, augmented reality applications, etc.

FIG. 2 illustrates content integrity mechanism 110 of FIG. 1 according to some embodiments. For brevity, many of the details already discussed with reference to FIG. 1 are not repeated or discussed hereafter. In one embodiment, content integrity mechanism 110 may include any number and type of elements or components, such as (but not limited to): storage logic 201; calculation logic 203; signature logic 205; generation logic 207; and communication/compatibility logic 209.

In the illustrated embodiment, computing device 100 represents a mobile computing device (also referred to as “mobile device”). In one example, the mobile device may be a client computing device.

Computing device 100 further includes user interface 219 (e.g., graphical user interface (GUI)-based user interface, Web browser, cloud-based platform user interface, software application-based user interface, other user or application programming interfaces (APIs), etc.). Computing device 100 may further include I/O source(s) 108 having input component(s) 231, such as camera(s) 242 (e.g., Intel® RealSense™ camera), microphone(s) 241, sensors, detectors, keyboards, mice, etc., and output component(s) 233, such as display device(s) or simply display(s) 244 (e.g., integral displays, tensor displays, projection screens, display screens, etc.), speaker devices(s) or simply speaker(s), etc.

Computing device 100 is further illustrated as having access to and/or being in communication with one or more database(s) 225 and/or one or more of other computing devices over one or more communication medium(s) 230 (e.g., networks such as a proximity network, a cloud network, an intranet, the Internet, etc.).

In some embodiments, database(s) 225 may include one or more of storage mediums or devices, repositories, data sources, etc., having any amount and type of information, such as data, metadata, etc., relating to any number and type of applications, such as data and/or metadata relating to one or more users, physical locations or areas, applicable laws, policies and/or regulations, user preferences and/or profiles, security and/or authentication data, historical and/or preferred details, and/or the like.

As aforementioned, computing device 100 may host I/O source(s) 108 including input component(s) 231 and output component(s) 233. In one embodiment, input component(s) 231 may include a sensor array including, but not limited to, microphone(s) 241, camera(s) 242, capacitors, radio components, radar components, scanners (e.g., fingerprint scanners), and/or accelerometers, etc. Similarly, output component(s) 233 may include any number and type of display device(s) 244, projectors, light-emitting diodes (LEDs), speaker(s) 243, and/or vibration motors, etc.

As aforementioned, terms like “logic”, “module”, “component”, “engine”, “circuitry”, “element”, and “mechanism” may include, by way of example, software, hardware, firmware, and/or any combination thereof. For example, logic may itself be or include or be associated with circuitry at one or more devices, such as content integrity circuitry 120 hosted by CPU 112, respectively, of FIG. 1 having to facilitate or execute the corresponding logic to perform certain tasks.

Embodiments provide for a novel technique, as facilitated by content integrity mechanism 110 for implementing digitally signed SQR codes of content. In one embodiment, storage logic 201 stores captured content as a hash map. In one example, the captured content includes at least one of image content and video content. In this example, photos and/or videos may be created with a preinstalled digital camera (e.g., camera(s) 242) on the computing device 100.

In one embodiment, the calculation logic 203 calculates a hash of the captured content. In one example, the calculated hash is a unique key that is stored in the hash map. For example, the calculation logic 203 may calculate the hash of an image/photo taken with the camera and use the hash as the unique key to store in the hash map. In one example, the signature logic 205 creates a digital signature for the captured content using a private key. In this regard, the captured content is digitally (e.g., cryptographically) signed. In one example, the generation logic 207 generates a SQR code of the digitally signed captured content.

In another example, the storage logic 201 stores the SQR code including the digitally signed captured content in a secure digital (SD) card/memory. In one example, the SQR code is stored as a value against the unique key (e.g., the hash calculated by calculation logic 203). In other examples, the SQR code including the digitally signed captured content may be transferred to a destination device (e.g., computing device 500B of FIG. 5B) for consumption. The digitally signed captured content may be verified at the destination device using a public key. The integrity of the captured content may be verified at the destination device using the unique key (e.g., the calculated hash value).

As such, multiple layers of protection are provided by the novel technology described herein. A first level of protection includes the generation of a SQR code of the digitally signed content preventing a fraudster from using the content (e.g., a photo, image, or video) source as it is. A second level of protection includes creating a signature for the content using a private key such that the content is digitally signed preventing theft of the content. Another level of protection includes a hash value check at the source device and the destination device to verify the integrity of the content.

It is contemplated that embodiments are not limited to any number or type of use-case scenarios, architectural placements, or component setups; however, for the sake of brevity and clarity, illustrations and descriptions are offered and discussed throughout this document for exemplary purposes but that embodiments are not limited as such. Further, throughout this document, “user” may refer to someone having access to one or more computing devices, such as computing device 100, and may be referenced interchangeably with “person”, “individual”, “human”, “him”, “her”, “child”, “adult”, “viewer”, “player”, “gamer”, “developer”, programmer”, and/or the like.

Communication/compatibility logic 209 may be used to facilitate dynamic communication and compatibility between various components, networks, database(s) 225, and/or communication medium(s) 230, etc., and any number and type of other computing devices (such as wearable computing devices, mobile computing devices, desktop computers, server computing devices, etc.), processing devices (e.g., central processing unit (CPU), graphics processing unit (GPU), etc.), capturing/sensing components (e.g., non-visual data sensors/detectors, such as audio sensors, olfactory sensors, haptic sensors, signal sensors, vibration sensors, chemicals detectors, radio wave detectors, force sensors, weather/temperature sensors, body/biometric sensors, scanners, etc., and visual data sensors/detectors, such as cameras, etc.), user/context-awareness components and/or identification/verification sensors/devices (such as biometric sensors/detectors, scanners, etc.), memory or storage devices, data sources, and/or database(s) (such as data storage devices, hard drives, solid-state drives, hard disks, memory cards or devices, memory circuits, etc.), network(s) (e.g., Cloud network, Internet, Internet of Things, intranet, cellular network, proximity networks, such as Bluetooth, Bluetooth low energy (BLE), Bluetooth Smart, Wi-Fi proximity, Radio Frequency Identification, Near Field Communication, Body Area Network, etc.), wireless or wired communications and relevant protocols (e.g., Wi-Fi®, WiMAX, Ethernet, etc.), connectivity and location management techniques, software applications/websites, (e.g., social and/or business networking websites, business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “tool”, “circuitry”, and/or the like, may be referenced interchangeably and include, by way of example, software, hardware, firmware, and/or any combination thereof. In one example, “logic” may refer to or include a software component that works with one or more of an operating system, a graphics driver, etc., of a computing device, such as computing device 100. In another example, “logic” may refer to or include a hardware component that is capable of being physically installed along with or as part of one or more system hardware elements, such as an application processor, a graphics processor, etc., of a computing device, such as computing device 100. In yet another embodiment, “logic” may refer to or include a firmware component that is capable of being part of system firmware, such as firmware of an application processor or a graphics processor, etc., of a computing device, such as computing device 100.

It is contemplated that any number and type of components may be added to and/or removed from content integrity mechanism 110 and/or content integrity circuitry 120 of FIG. 1 and FIG. 2 to facilitate various embodiments including adding, removing, and/or enhancing certain features. For brevity, clarity, and ease of understanding of content integrity mechanism 110 and/or content integrity circuitry 120 of FIG. 1 and FIG. 2, many of the standard and/or known components, such as those of a computing device are not shown or discussed here. It is contemplated that embodiments, as described herein, are not limited to any technology, topology, system, architecture, and/or standard and are dynamic enough to adopt and adapt to any future changes.

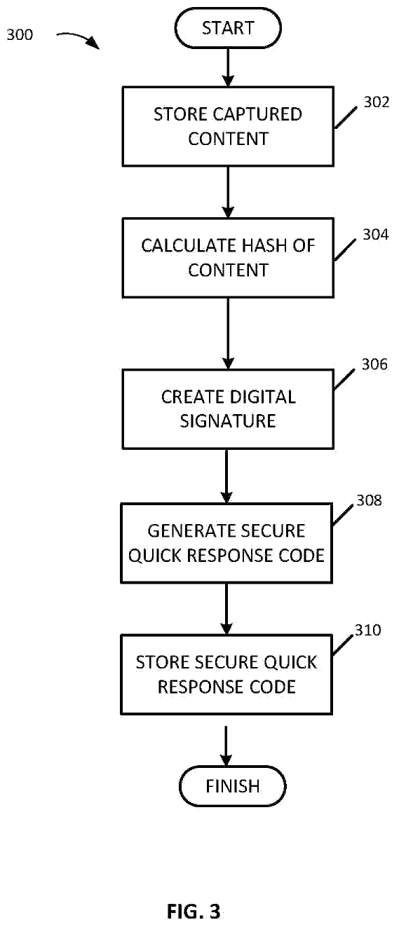

FIG. 3 illustrates a method 300 for generating digitally signed SQR codes according to some embodiments. Method 300 may be implemented on a computing device or a similar electronic device capable of executing instructions through at least one processor. Process 300 may begin at operation 302, where captured content is stored as a hash map. When captured content is stored as a hash map, flow proceeds to operation 304 where a hash of the captured content is calculated. In one example, the hash is a unique key that is stored in the hash map. At operation 306, a digital signature is created for the captured content using a private key such that the captured content is digitally signed. At operation 308, a SQR code of the digitally signed captured content is generated. At operation 310, the SQR code including the digitally signed captured content is stored in a SD card.

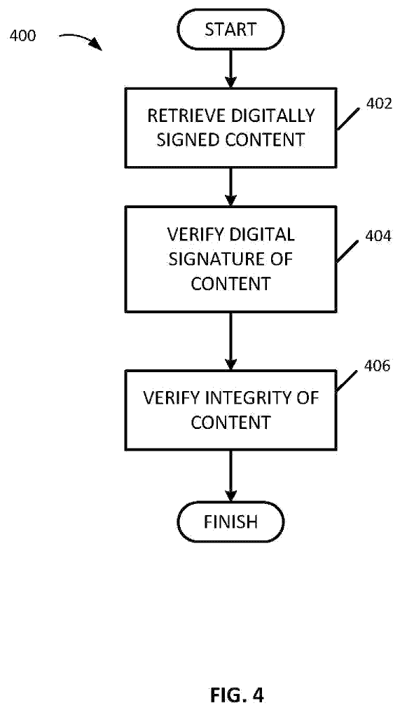

FIG. 4 illustrates a method 400 for verifying digitally signed SQR codes according to some embodiments. Method 400 may be implemented on a computing device or a similar electronic device capable of executing instructions through at least one processor. Process 400 may begin at operation 402, where digitally signed content is retrieved. In one example, digitally signed content in the form of a SQR code is received at a destination device. In another example, when the digitally signed content in the form of a SQR code is received, the digitally signed content may be retrieved using a SQR code reader.

When the digitally signed content is retrieved, flow proceeds to operation 404 where the digitally signed content is verified using a public key. For example, the public key may be used to verify the authenticity of the sender of the content. At operation 406, the integrity of the content is verified. In one example, the integrity of the content is verified using a unique key. The unique key may be a hash value of the content calculated at a source device.

FIG. 5A is a schematic diagram of an illustrative electronic computing device to perform digitally signed SQR code processing to some embodiments. In some embodiments, computing device 500A includes one or more processors 510 including processor cores 518 and content integrity circuitry 120. In some embodiments, the computing device 500A includes one or more hardware accelerators 568. In some embodiments, the computing device is to implement processing of software-defined performance monitoring events, as provided in FIGS. 1-4 above.

The computing device 500A may additionally include one or more of the following: cache 562, a graphical processing unit (GPU) 512 (which may be the hardware accelerator in some implementations), a wireless input/output (I/O) interface 520, a wired I/O interface 530, system memory 540, power management circuitry 580, non-transitory storage device 560, and a network interface 570 for connection to a network 572. The following discussion provides a brief, general description of the components forming the illustrative computing device 500A. Example, non-limiting computing devices 500A may include a desktop computing device, blade server device, workstation, laptop computer, mobile phone, tablet computer, personal digital assistant, or similar device or system.

In embodiments, the processor cores 518 are capable of executing machine-readable instruction sets 514, reading data and/or machine-readable instruction sets 514 from one or more storage devices 560 and writing data to the one or more storage devices 560. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like. For example, machine-readable instruction sets 514 may include instructions to implement security processing, as provided in FIGS. 1-4.

The processor cores 518 may include any number of hardwired or configurable circuits, some or all of which may include programmable and/or configurable combinations of electronic components, semiconductor devices, and/or logic elements that are disposed partially or wholly in a PC, server, mobile phone, tablet computer, or other computing system capable of executing processor-readable instructions.

The computing device 500A includes a bus 516 or similar communications link that communicably couples and facilitates the exchange of information and/or data between various system components including the processor cores 518, the cache 562, the graphics processor circuitry 512, one or more wireless I/O interface 520, one or more wired I/O interfaces 530, one or more storage devices 560, and/or one or more network interfaces 570. The computing device 500A may be referred to in the singular herein, but this is not intended to limit the embodiments to a single computing device 500A, since in certain embodiments, there may be more than one computing device 500A that incorporates, includes, or contains any number of communicably coupled, collocated, or remote networked circuits or devices.

The processor cores 518 may include any number, type, or combination of currently available or future developed devices capable of executing machine-readable instruction sets.

The processor cores 518 may include (or be coupled to) but are not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 5A are of conventional design. Consequently, such blocks need not be described in further detail herein, as they will be understood by those skilled in the relevant art. The bus 516 that interconnects at least some of the components of the computing device 500A may employ any currently available or future developed serial or parallel bus structures or architectures.

The system memory 540 may include read-only memory (“ROM”) 542 and random-access memory (“RAM”) 546. A portion of the ROM 542 may be used to store or otherwise retain a basic input/output system (“BIOS”) 544. The BIOS 544 provides basic functionality to the computing device 500A, for example by causing the processor cores 518 to load and/or execute one or more machine-readable instruction sets 514. In embodiments, at least some of the one or more machine-readable instruction sets 514 cause at least a portion of the processor cores 518 to provide, create, produce, transition, and/or function as a dedicated, specific, and particular machine, for example a word processing machine, a digital image acquisition machine, a media playing machine, a gaming system, a communications device, a smartphone, a neural network, a machine learning model, or similar devices.

The computing device 500A may include at least one wireless input/output (I/O) interface 520. The at least one wireless I/O interface 520 may be communicably coupled to one or more physical output devices 522 (tactile devices, video displays, audio output devices, hardcopy output devices, etc.). The at least one wireless I/O interface 520 may communicably couple to one or more physical input devices 524 (pointing devices, touchscreens, keyboards, tactile devices, etc.). The at least one wireless I/O interface 520 may include any currently available or future developed wireless I/O interface. Example wireless I/O interfaces include, but are not limited to: BLUETOOTH®, near field communication (NFC), and similar.

The computing device 500A may include one or more wired input/output (I/O) interfaces 530. The at least one wired I/O interface 530 may be communicably coupled to one or more physical output devices 522 (tactile devices, video displays, audio output devices, hardcopy output devices, etc.). The at least one wired I/O interface 530 may be communicably coupled to one or more physical input devices 524 (pointing devices, touchscreens, keyboards, tactile devices, etc.). The wired I/O interface 530 may include any currently available or future developed I/O interface. Example wired I/O interfaces include but are not limited to universal serial bus (USB), IEEE 1394 (“FireWire”), and similar.

The computing device 500A may include one or more communicably coupled, non-transitory, storage devices 560. The storage devices 560 may include one or more hard disk drives (HDDs) and/or one or more solid-state storage devices (SSDs). The one or more storage devices 560 may include any current or future developed storage appliances, network storage devices, and/or systems. Non-limiting examples of such storage devices 560 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more storage devices 560 may include one or more removable storage devices, such as one or more flash drives, flash memories, flash storage units, or similar appliances or devices capable of communicable coupling to and decoupling from the computing device 500A.

The one or more storage devices 560 may include interfaces or controllers (not shown) communicatively coupling the respective storage device or system to the bus 516. The one or more storage devices 560 may store, retain, or otherwise contain machine-readable instruction sets, data structures, program modules, data stores, databases, logical structures, and/or other data useful to the processor cores 518 and/or graphics processor circuitry 512 and/or one or more applications executed on or by the processor cores 518 and/or graphics processor circuitry 512. In some instances, one or more data storage devices 560 may be communicably coupled to the processor cores 518, for example via the bus 516 or via one or more wired communications interfaces 530 (e.g., Universal Serial Bus or USB); one or more wireless communications interface 520 (e.g., Bluetooth®, Near Field Communication or NFC); and/or one or more network interfaces 570 (IEEE 802.3 or Ethernet, IEEE 802.11, or Wi-Fi®, etc.).

Machine-readable instruction sets 514 and other programs, applications, logic sets, and/or modules may be stored in whole or in part in the system memory 540. Such machine-readable instruction sets 514 may be transferred, in whole or in part, from the one or more storage devices 560. The machine-readable instruction sets 514 may be loaded, stored, or otherwise retained in system memory 540, in whole or in part, during execution by the processor cores 518 and/or graphics processor circuitry 512.

The computing device 500A may include power management circuitry 580 that controls one or more operational aspects of the energy storage device 582. In embodiments, the energy storage device 582 may include one or more primary (i.e., non-rechargeable) or secondary (i.e., rechargeable) batteries or similar energy storage devices. In embodiments, the energy storage device 582 may include one or more supercapacitors or ultracapacitors. In embodiments, the power management circuitry 580 may alter, adjust, or control the flow of energy from an external power source 584 to the energy storage device 582 and/or to the computing device 500A. The external power source 584 may include, but is not limited to, a solar power system, a commercial electric grid, a portable generator, an external energy storage device, or any combination thereof.

For convenience, the processor cores 518, the graphics processor circuitry 512, the wireless I/O interface 520, the wired I/O interface 530, the storage device 560, and the network interface 570 are illustrated as communicatively coupled to each other via the bus 516, thereby providing connectivity between the above-described components. In alternative embodiments, the above-described components may be communicatively coupled in a different manner than illustrated in FIG. 5A. For example, one or more of the above-described components may be directly coupled to other components, or may be coupled to each other, via one or more intermediary components (not shown). In another example, one or more of the above-described components may be integrated into the processor cores 518 and/or the graphics processor circuitry 512. In some embodiments, all or a portion of the bus 516 may be omitted and the components are coupled directly to each other using suitable wired or wireless connections.

Flow charts representative of example hardware logic, machine readable instructions, hardware implemented state machines, and/or any combination thereof for implementing computing device 500A, for example, are shown in FIG. 3 and FIG. 4. The machine-readable instructions may be one or more executable programs or portion(s) of an executable program for execution by a computer processor such as the processor 510 shown in the example computing device 500A discussed above in connection with FIG. 5A. The program may be embodied in software stored on a non-transitory computer readable storage medium such as a CD-ROM, a floppy disk, a hard drive, a DVD, a Blu-ray disk, or a memory associated with the processor 510, but the entire program and/or parts thereof could alternatively be executed by a device other than the processor 510 and/or embodied in firmware or dedicated hardware. Further, although the example program is described with reference to the flow charts illustrated in FIG. 3 and FIG. 4, many other methods of implementing the example computing device 500A may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine-readable instructions may be stored in multiple parts, which are individually compressed, encrypted, and stored on separate computing devices, wherein the parts when decrypted, decompressed, and combined form a set of executable instructions that implement a program such as that described herein.

In another example, the machine-readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine-readable instructions may be configured (e.g., settings stored, data input, network addresses recorded, etc.) before the machine-readable instructions and/or the corresponding program(s) can be executed in whole or in part. Thus, the disclosed machine-readable instructions and/or corresponding program(s) are intended to encompass such machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example methods of FIG. 3 and FIG. 4 may be implemented using executable instructions (e.g., computer and/or machine-readable instructions) stored on a non-transitory computer and/or machine-readable medium such as a hard disk drive, a solid-state storage device (SSD), a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended.

The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

FIG. 5B is a schematic diagram of an illustrative electronic computing device to perform digitally signed SQR code processing according to some embodiments. In some embodiments, the computing device 500B represents a destination device as described herein. In some embodiments, computing device 500B includes one or more processors 510 including content verification circuitry 502.

In some embodiments, the computing device 500B is to implement processing of software-defined performance monitoring events, as provided in FIGS. 1-4 above. The computing device 500B may additionally include the components forming the illustrative computing device 500A described herein relative to FIG. 5A such as one or more of the following: cache 562, a graphical processing unit (GPU) 512 (which may be the hardware accelerator in some implementations), a wireless input/output (I/O) interface 520, a wired I/O interface 530, system memory 540, power management circuitry 580, non-transitory storage device 560, a network interface 570 for connection to a network 572, machine-readable instructions sets 514, one or more storage devices 560, and the like. In this regard, the computing device 500B may include any or all of the non-limiting examples of computing device 500A described relative to FIG. 5A. Additionally, the computing device 500B may perform, execute and/or implement processing of any or all of the functions, methods, processes performed, executed and/or implemented by computing device 500A described relative to FIG. 5A.

Furthermore, the content verification circuitry 502 is capable of executing machine-readable instruction sets 514, reading data and/or machine-readable instruction sets 514 from one or more storage devices 560 and writing data to the one or more storage devices 560. In this regard, the content verification circuitry 502 may include any or all the functionality of the content integrity circuitry 120 described relative to FIG. 1 and FIG. 5A.

The following examples pertain to further embodiments. Example 1 is a method including storing captured content as a hash map, calculating a hash of the captured content, where the hash is a unique key that is stored in the hash map, creating a digital signature for the captured content using a private key such that the captured content is digitally signed, generating a secure quick response (SQR) code of the digitally signed captured content, and storing the SQR code including the digitally signed captured content in a secure digital (SD) card.

In Example 2, the subject matter of Example 1 can optionally include wherein the captured content is created using a pre-installed digital camera.

In Example 3, the subject matter of any one of Examples 1-2 can optionally include wherein the SQR code is stored as a value against the unique key.

In Example 4, the subject matter of any one of Examples 1-3 can optionally include wherein the captured content is at least one of image content and video content.

In Example 5, the subject matter of any one of Examples 1-4 can optionally include further comprising initiating the transfer of the SQR code including the digitally signed captured content to a destination device for consumption.

In Example 6, the subject matter of any one of Examples 1-5 can optionally include wherein the digitally signed captured content is verified using a public key at the destination device.

In Example 7, the subject matter of any one of Examples 1-6 can optionally include wherein integrity of the captured content is verified using the unique key at the destination device.

Example 8 is at least one non-transitory machine-readable storage medium comprising instructions that, when executed, cause at least one processing device to at least: store captured content as a hash map, calculate a hash of the captured content, where the hash is a unique key that is stored in the hash map, create a digital signature for the captured content using a private key such that the captured content is digitally signed, generate a secure quick response (SQR) code of the digitally signed captured content, and store the SQR code including the digitally signed captured content in a secure digital (SD) card.

In Example 9, the subject matter of Example 8 can optionally include wherein the captured content is created using a pre-installed digital camera.

In Example 10, the subject matter of any one of Examples 8-9 can optionally include wherein the SQR code is stored as a value against the unique key.

In Example 11, the subject matter of any one of Examples 8-10 can optionally include wherein the captured content is at least one of image content and video content.

In Example 12, the subject matter of any one of Examples 8-11 can optionally include wherein the instructions that, when executed, further cause the at least one processing device to at least initiate the transfer of the SQR code including the digitally signed captured content to a destination device for consumption.

In Example 13, the subject matter of any one of Examples 8-12 can optionally include wherein the digitally signed captured content is verified using a public key at the destination device.

In Example 14, the subject matter of any one of Examples 8-13 can optionally include wherein integrity of the captured content is verified using the unique key at the destination device.

Example 15 is an apparatus comprising: one or more processors to: store captured content as a hash map, calculate a hash of the captured content, where the hash is a unique key that is stored in the hash map, create a digital signature for the captured content using a private key such that the captured content is digitally signed, generate a secure quick response (SQR) code of the digitally signed captured content, and store the SQR code including the digitally signed captured content in a secure digital (SD) card.

In Example 16, the subject matter of Example 15 can optionally include wherein the captured content is created using a pre-installed digital camera.

In Example 17, the subject matter of any one of Examples 15-16 can optionally include wherein the SQR code is stored as a value against the unique key.

In Example 18, the subject matter of any one of Examples 15-17 can optionally include wherein the captured content is at least one of image content and video content.

In Example 19, the subject matter of any one of Examples 15-18 can optionally include wherein the one or more processors further initiate the transfer of the SQR code including the digitally signed captured content to a destination device for consumption.

In Example 20, the subject matter of any one of Examples 15-19 can optionally include wherein the digitally signed captured content is verified using a public key at the destination device.

Example 21 is a system including one or more processors coupled to a memory, wherein the one or more processors are operative to perform the method of any one of Examples 1 to 7.

Example 22 is a method including retrieving digitally signed content, verifying the digitally signed content using a public key, and verifying the integrity of the content.

In Example 23, the subject matter of Example 22 can optionally include wherein the digitally signed content is in the form of a SQR code.

In Example 24, the subject matter of any one of Examples 22-23 can optionally include wherein the digitally signed content is retrieved using a SQR reader.

In Example 25, the subject matter of any one of Examples 22-24 can optionally include further comprising receiving the digitally signed content in the form of a SQR code from a source device.

In Example 26, the subject matter of any one of Examples 22-25 can optionally include wherein the public key is used to verify the authenticity of a sender of the digitally signed content.

In Example 27, the subject matter of any one of Examples 22-26 can optionally include wherein the integrity of the content is verified using a unique key.

In Example 28, the subject matter of any one of Examples 22-27 can optionally include wherein the unique key is a hash value of the content, where the hash value of the content is calculated at the source device.

Example 29 is a system including one or more processors coupled to a memory, wherein the one or more processors are operative to perform the method of any one of Examples 22 to 28.

Example 30 is an apparatus comprising one or more processors to perform the method of any one of Examples 22 to 28.

Example 31 is at least one non-transitory machine-readable storage medium comprising instructions that, when executed, cause at least one processing device to perform the method of any one of Examples 22 to 28.

The foregoing description and drawings are to be regarded in an illustrative rather than a restrictive sense. Persons skilled in the art will understand that various modifications and changes may be made to the embodiments described herein without departing from the broader spirit and scope of the features set forth in the appended claims.

What is claimed is:

1. A method comprising:
storing captured content as a hash map;
calculating a hash of the captured content, where the hash is a unique key that is stored in the hash map;
creating a digital signature for the captured content using a private key such that the captured content is digitally signed;
generating a secure quick response (SQR) code of the digitally signed captured content; and
storing the SQR code including the digitally signed captured content in a secure digital (SD) card.

2. The method of claim 1, wherein the captured content is created using a pre-installed digital camera.

3. The method of claim 1, wherein the SQR code is stored as a value against the unique key.

4. The method of claim 1, wherein the captured content is at least one of image content and video content.

5. The method of claim 1, further comprising initiating the transfer of the SQR code including the digitally signed captured content to a destination device for consumption.

6. The method of claim 5, wherein the digitally signed captured content is verified using a public key at the destination device.

7. The method of claim 5, wherein integrity of the captured content is verified using the unique key at the destination device.

8. At least one non-transitory machine-readable storage medium comprising instructions that, when executed, cause at least one processing device to at least:
store captured content as a hash map;
calculate a hash of the captured content, where the hash is a unique key that is stored in the hash map;
create a digital signature for the captured content using a private key such that the captured content is digitally signed;
generate a secure quick response (SQR) code of the digitally signed captured content; and
store the SQR code including the digitally signed captured content in a secure digital (SD) card.

9. The at least one non-transitory machine-readable storage medium of claim 8, wherein the captured content is created using a pre-installed digital camera.

10. The at least one non-transitory machine-readable storage medium of claim 8, wherein the SQR code is stored as a value against the unique key.

11. The at least one non-transitory machine-readable storage medium of claim 8, wherein the captured content is at least one of image content and video content.

12. The at least one non-transitory machine-readable storage medium of claim 8, wherein the instructions that, when executed, further cause the at least one processing device to at least initiate the transfer of the SQR code including the digitally signed captured content to a destination device for consumption.

13. The at least one non-transitory machine-readable storage medium of claim 12, wherein the digitally signed captured content is verified using a public key at the destination device.

14. The at least one non-transitory machine-readable storage medium of claim 12, wherein integrity of the captured content is verified using the unique key at the destination device.

15. An apparatus comprising:
one or more processors to:
store captured content as a hash map;
calculate a hash of the captured content, where the hash is a unique key that is stored in the hash map;
create a digital signature for the captured content using a private key such that the captured content is digitally signed;
generate a secure quick response (SQR) code of the digitally signed captured content; and
store the SQR code including the digitally signed captured content in a secure digital (SD) card.

16. The apparatus of claim 15, wherein the captured content is created using a pre-installed digital camera.

17. The apparatus of claim 15, wherein the SQR code is stored as a value against the unique key.

18. The apparatus of claim 15, wherein the captured content is at least one of image content and video content.

19. The apparatus of claim 15, wherein the one or more processors further initiate the transfer of the SQR code including the digitally signed captured content to a destination device for consumption.

20. The apparatus of claim 19, wherein the digitally signed captured content is verified using a public key at the destination device.
